(19) United States
(12) Patent Application Publication
(10) Pub. No.: US 2009/0253531 A1
(43) Pub. Date: Oct. 8, 2009

(54) GOLF CLUB AND MANUFACTURING METHOD THEREOF

(75) Inventors: Kazuhiro Doi, Osaka (JP); Takayuki Mine, Gifu (JP); Masami Oohashi, Gifu (JP); Tomoaki Aoki, Osaka (JP)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignees: Mizuno Corporation, Osaka (JP); Mizuno Technics Corporation, Gifu (JP)

(21) Appl. No.: 12/414,525

(22) Filed: Mar. 30, 2009

(30) Foreign Application Priority Data
Mar. 31, 2008 (JP) 2008-093428
Mar. 12, 2009 (JP) 2009-059146

(51) Int. Cl. A63B 53/04; B23P 17/00

(52) U.S. Cl. 473/324; 72/362; 29/592

(57) ABSTRACT

A golf club attaining good hitting feeling is provided by realizing uniform distribution of grain flows in a face portion. The golf club includes a golf head including a face portion with a ball hitting surface and a neck portion connecting the face portion to a shaft. Grain flows are formed in the golf head, and density of grain flows inside the golf head is made comparable to density of grain flows at a surface layer portion.

This nonprovisional application is based on Japanese Patent Application No. 2008-093428 filed on Mar. 31, 2008 with the Japan Patent Office, and No. 2009-059146 filed on Mar. 12, 2009, the entire contents of which are hereby incorporated by reference.

### BACKGROUND OF THE INVENTION

1. Field of the Invention

The present invention relates to golf club and its manufacturing method and, more specifically, to a golf club having a face portion and a neck portion formed integrally, as well as to the method of manufacturing the same.

2. Description of the Background Art

Generally, a head portion of a golf club includes a face portion having a ball-hitting surface and a neck portion connecting the face portion to a shaft. Conventionally, when a golf club head is formed by forging, the face and neck portions are formed integrally as one piece. The resulting head, however, has a disadvantage that the neck portion tends to deform at the time of hitting. Therefore, the neck portion must be made thick, and it has been difficult to reduce mass distribution to the neck portion. Alternatively, the face portion and the neck portion may be formed through different manufacturing steps and thereafter joined to each other. In that case, strength at the joint portion between the face and neck portions is inevitably low.

As a solution to such problems, International Publication WO01/056666 proposes a golf club.

In the golf club described in the pamphlet of WO01/056666 mentioned above, however, distribution of grain flows in the face portion is uneven, so that strength and toughness undesirably vary position to position at the face portion and, because of this, it has been difficult to attain satisfactory hitting feeling when one hits the ball with a conventional golf club.

### SUMMARY OF THE INVENTION

The present invention was made in view of the foregoing, and its object is to provide a golf club that attains satisfactory hitting feeling by realizing uniform distribution of grain flows in the golf head, as well as to provide a method of manufacturing the same.

The present invention provides a golf club, including a golf head including a face portion with a ball hitting surface and a neck portion connecting the face portion to a shaft; wherein grain flows are formed in the golf head, and density of the grain flows inside the golf head is made comparable to density of the grain flows at a surface layer portion of the golf head.

The method of manufacturing the golf club in accordance with the present invention includes the drawing step of drawing a bar-shaped member to reduce diameter of the bar-shaped member; the reducing step of reducing diameter of one end of the bar-shaped member that has been drawn at the drawing step, to be smaller than the diameter of the other end; the bending step of bending the bar-shaped member; and the forging step, following the bending step, of forging the bar-shaped member to integrally form the face portion and the neck portion.

Preferably, the drawing step includes the step of hardening at least a part of circumferential surface of the bar-shaped member, while retaining grain flows.

Preferably, the forging step includes a first forging step of performing a plurality of coarse forging steps on the bar-shaped member to bring the bar-shaped member closer to a final shape while retaining grain flows, and a second forging step of performing fine forging process on a body resulting from the coarse forging steps, to attain the final shape.

In the golf club in accordance with the present invention, substantially uniform distribution of grain flows can be attained in the golf head, and satisfactory hitting feeling can be attained. By the method of manufacturing a golf club in accordance with the present invention, a golf club having grain flows distributed substantially uniformly in the golf club head can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of the golf club head 10 in accordance with the present invention.

FIG. 2 is a cross-sectional view schematically showing a cross-section of the head.

FIG. 3 is a cross sectional view showing a first step of manufacturing the golf club in accordance with the present invention.

FIG. 4 is a cross sectional view showing a second step of manufacturing the golf club in accordance with the present invention.

FIG. 5 is a cross sectional view showing a third step of manufacturing the golf club in accordance with the present invention.

FIG. 6 is a cross sectional view showing a fourth step of manufacturing the golf club in accordance with the present invention.

FIG. 7 is a cross sectional view showing a fifth step of manufacturing the golf club in accordance with the present invention.

FIG. 8 is another cross sectional view showing the fifth step of manufacturing the golf club in accordance with the present invention.

FIG. 9 is a cross sectional view showing a sixth step of manufacturing the golf club in accordance with the present invention.

FIG. 10 is another cross sectional view showing the sixth step of manufacturing the golf club in accordance with the present invention.

FIG. 11 is a cross sectional view showing a seventh step of manufacturing the golf club in accordance with the present invention.

FIG. 12 is another cross sectional view showing the seventh step of manufacturing the golf club in accordance with the present invention.

FIG. 13 is a cross sectional view showing an eighth step of manufacturing the golf club in accordance with the present invention.

FIG. 14 is another cross sectional view showing the eighth step of manufacturing the golf club in accordance with the present invention.

FIGS. 15 to 21 are cross sectional views of a material at various manufacturing steps in accordance with the present invention.

FIG. 22 is a photograph showing a cross-section of a face portion of the head of golf club in accordance with an embodiment.

FIG. 23 is a photograph showing a cross-section of a neck portion.

FIG. 24 is a photograph showing a cross-section of a face portion of the head of golf club of a comparative example.

FIG. 25 is a cross-sectional view of a neck portion 12 of the golf club in accordance with the comparative example.

FIG. 26 is a graph showing hardness of golf clubs in accordance with the embodiment and the comparative example mentioned above.

FIG. 27 is a cross sectional view of the face portion indicating points where the hardness of FIG. 26 were measured.

FIG. 28 is a cross sectional view of the neck portion indicating points where the hardness of FIG. 26 were measured.

FIG. 29 is a graph showing measurement of sound generated at a trial of the golf club in accordance with an embodiment.

### DESCRIPTION OF THE PREFERRED EMBODIMENTS

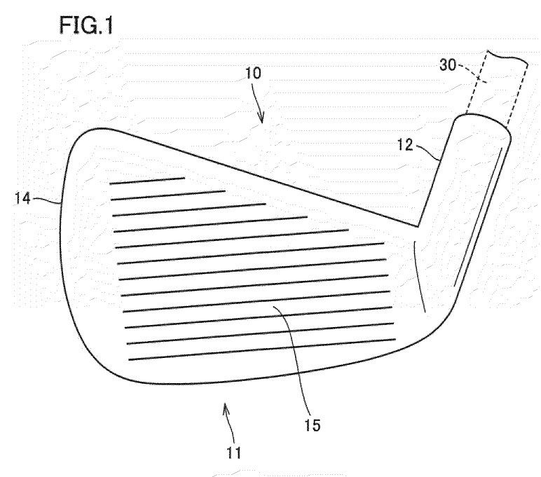

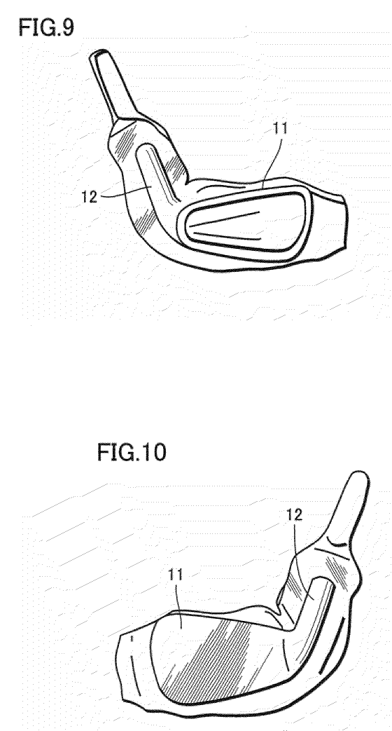

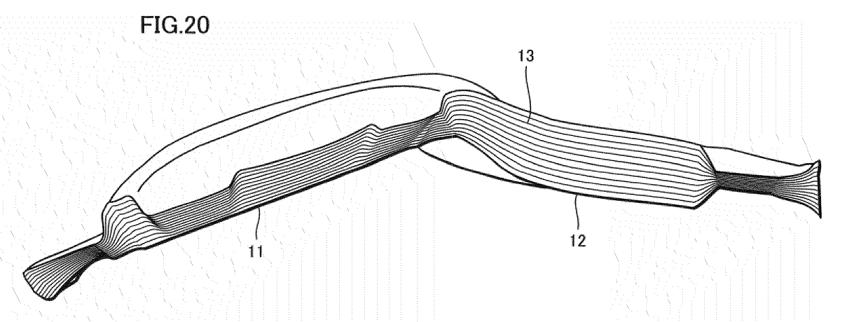

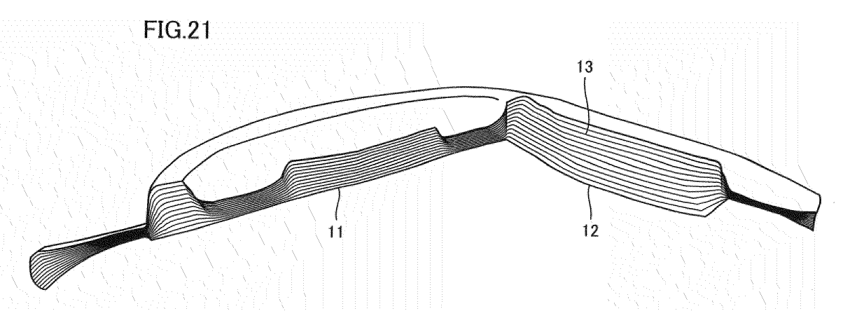

The golf club and its manufacturing method in accordance with the present invention will be described with reference to FIGS. 1 to 29. In the embodiments described in the following, descriptions of numbers, amounts and the like are not intended to limit the scope of the invention unless otherwise specified. Further, in the embodiments below, each component is not always necessary, unless otherwise specified. When a plurality of embodiments are possible, it is naturally expected that structures of various embodiments are appropriately combined, unless otherwise specified.

FIG. 1 is a front view of a head (golf head) 10 of a golf club in accordance with the present invention. As shown in FIG. 1, head 10 includes a face portion 11 having a ball hitting surface 15, and a neck portion 12 connecting face portion 11 and a shaft 30.

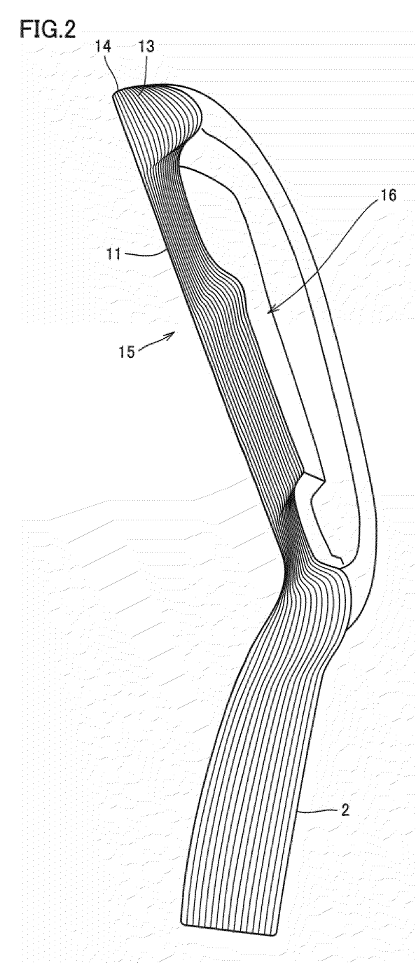

FIG. 2 is a cross-sectional view schematically showing a cross-section of head 10. As shown in FIG. 2, in head 10, a plurality of grain flows 13 are formed continuously from neck portion 12 to face portion 11.

Most of the grain flows 13 extend continuously from neck portion 12 to face portion 11 and, at face portion 11, grain flows 13 extend continuously in one direction.

In face portion 11, grain flows 13 extend from a connecting portion to neck portion 12 to a toe portion 14. As the grain flows 13 continuously extend from neck portion 12 to face portion 11, strength at the connecting portion between face portion 11 and neck portion 12 can be improved.

Distribution density of grain flows 13 at the ball hitting surface 15 of face portion 11 is comparable to the distribution density of grain flows 13 inside the face portion 11. Specifically, at face portion 11, grain flows are distributed substantially uniformly from the side of ball hitting surface 15 to the side of a rear surface 16.

Here, strength and toughness of head 10 of the golf club in accordance with the present embodiment are made uniform, possibly because of uniform distribution of grain flows 13 in head 10.

Observation revealed that the crystal structure of face portion 11 was not a layered structure, and that the metal was well hardened. It can be seen from this that hardness of face portion 11 has also been improved.

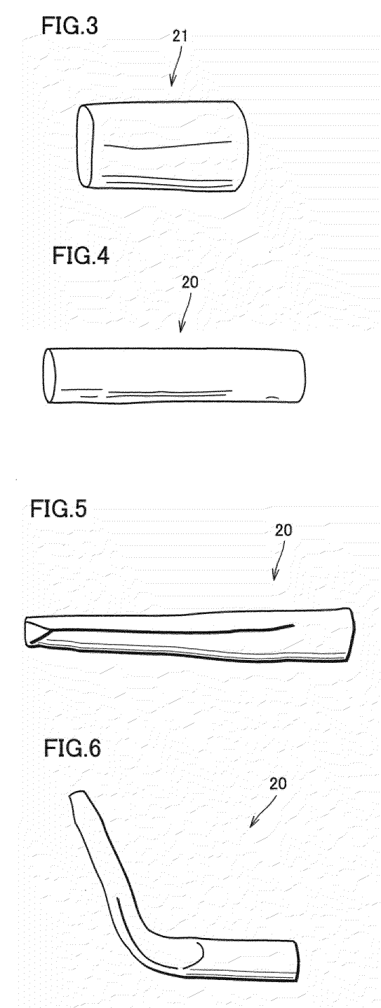

Referring to FIGS. 3 to 20, the method of manufacturing the golf club in accordance with the present embodiment will be described. As shown in FIG. 3, a bar-shaped member 21 formed, for example, of carbon steel is prepared. The bar-shaped member has a diameter of, for example, about 50 mm.

Then, as shown in FIG. 4, drawing (forging) is done to form a bar-shaped member 20 having smaller cross-sectional area than bar-shaped member 21. The diameter of bar-shaped member 20 is, for example, about 27 mm. In the drawing process, bar-shaped member 21 may be rotated while circumferential surface of bar-shaped member 21 is substantially uniformly hardened with a hammer or a roll, or part of the circumferential surface of bar-shaped member 21 may not be hardened.

By the hardening of bar-shaped member 21, the diameter of bar-shaped member 21 can be reduced while maintaining grain flows 13, whereby bar-shaped member 20 is formed.

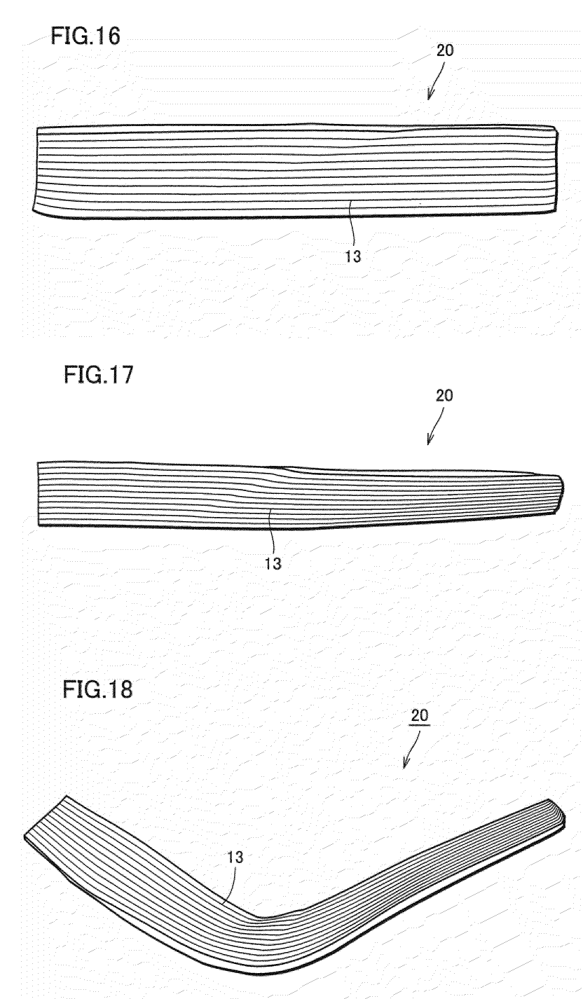

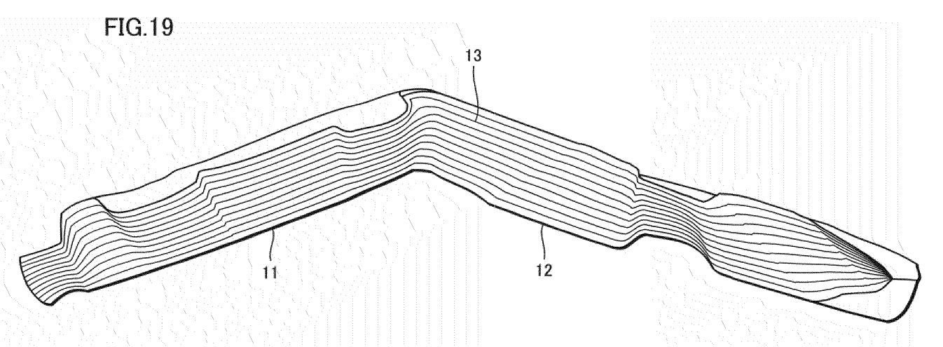

FIG. 15 is a schematic cross-sectional view showing the cross-section of bar-shaped member 21, and FIG. 16 is a schematic cross-sectional view showing the cross-section of bar-shaped member 20. As shown in FIGS. 15 and 16, distribution density of grain flows 13 in bar-shaped member 20 is considered to be higher than the distribution density of grain flows 13 in bar-shaped member 21. The distribution density of grain flows 13 is determined by the grain flows 13 that can be observed in normal visible state of the cross-section.

As shown in FIG. 5, one end of bar-shaped member 20 is subjected to area-reducing process so that its cross-sectional area is reduced. The area-reducing process is done, for example, by rolling one end of bar-shaped member 20, using a roll. Here, attention must be paid so as not to disrupt grain flows 13 in bar-shaped member 20, as shown in FIG. 17.

By such plastic working on one side of bar-shaped member 20, cross-sectional area of the said one side is made smaller and hence, density of grain flows 13 on the one side of bar-shaped member 20 can be increased as shown in FIG. 17. Thus, as shown in FIG. 17, density of grain flows 13 on one end of bar-shaped member 20 can be increased.

Neck body 12 is formed on this end, and face body 11 is formed on the other end. Consequently, it is expected that density of grain flows 13 at the neck body 20 can be increased to be higher than the density of grain flows 13 at the face body 11, as shown in FIG. 18.

A process other than the drawing process described above may be adopted, provided that the cross-sectional area of bar-shaped member 20 can be reduced by plastic deformation of one end of bar-shaped member 20.

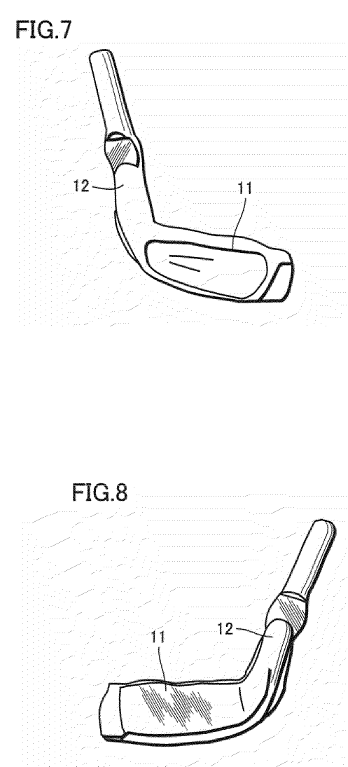

Next, as shown in FIG. 6, bar-shaped member 20 is bent. Thereafter, as shown in FIGS. 7 to 12, three steps of coarse forging are performed, using metal molds and a hammer of 1 ton.

In the coarse forging process, the bar-shaped member 20 is subjected to stepwise plastic deformation, so that it becomes possible to retain substantially perfect grain flows 13 in the material as shown in FIGS. 19 to 21. Further, in the coarse forging process, the bar-shaped member 20 is subjected to stepwise plastic deformation, so that it becomes possible to have grain flows 13 continuously extend from neck body 12 to face body 11, to have grain flows 13 extend in layers along the hitting surface 15 of face body 11, and to have grain flows 13 distributed uniformly from the side of ball hitting surface 15 to the rear side 16 of face body 11.

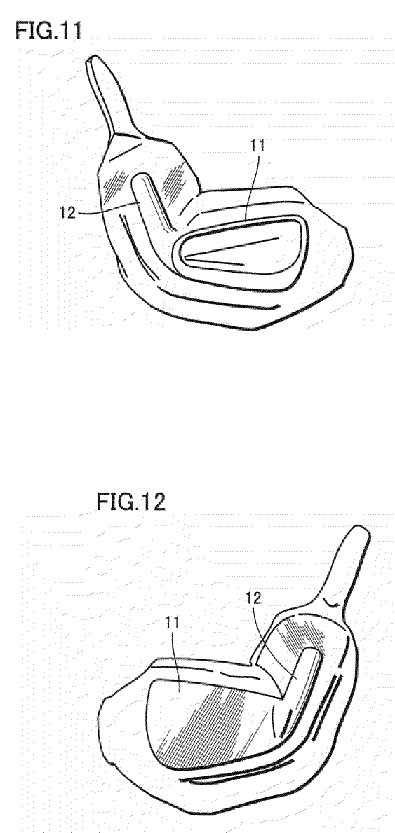

Further, by the three steps of coarse forging, deformation to almost finished shape can be attained as shown in FIGS. 11 and 12. Therefore, the final golf club head can be completed simply by the fine forging process as will be described later. As a result, additional machine processing is unnecessary at the final stage and, hence, partial disruption of grain flows 13 can be prevented.

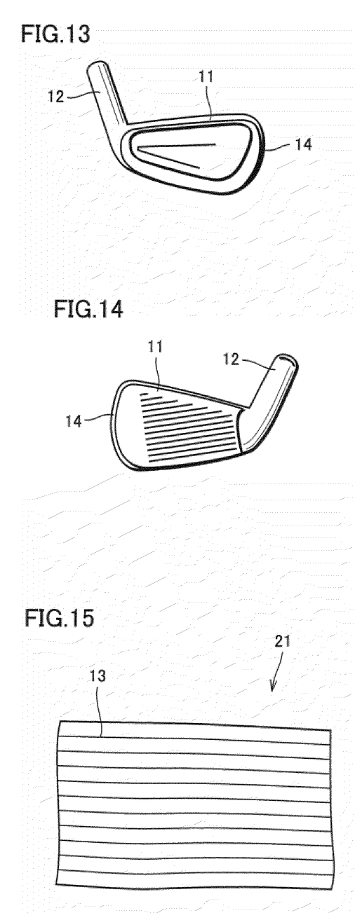

Next, after trimming, the fine forging process is performed as the finishing process, and details such as score lines are formed, as shown in FIGS. 13 and 14. Through the above-described steps, head body 10 having integrally formed face body 11 and neck body 12 can be obtained, with substantially perfect grain flows 13 maintained. To the head body 10 as such, shaft 30 and the like are mounted, whereby a golf club is complete.

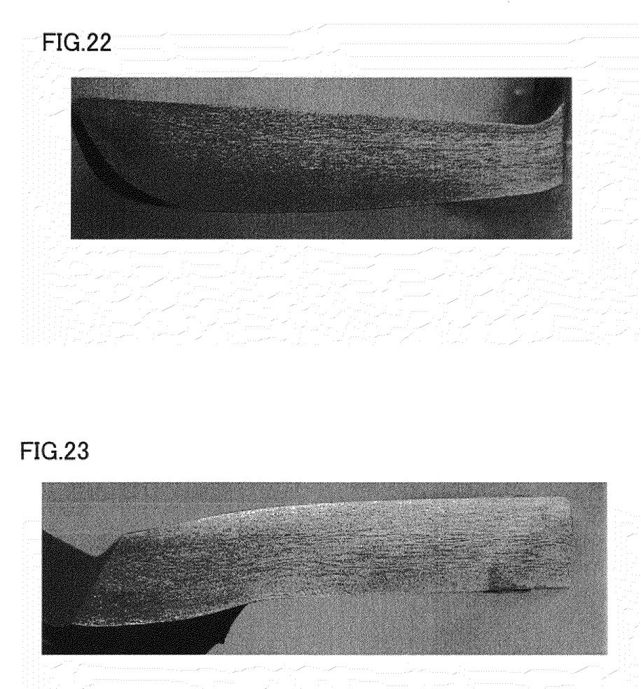

FIG. 22 is a photograph showing a cross-section of face portion 11 of head 10, of the golf club in accordance with the present embodiment. FIG. 23 is a photograph showing a cross-section of neck portion 12.

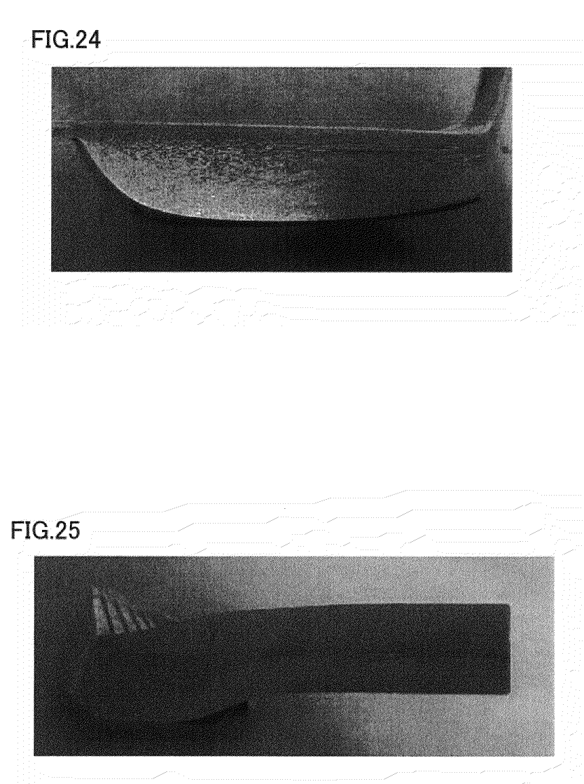

FIG. 24 is a photograph showing a cross-section of the face portion of head portion of a golf club as a comparative example. FIG. 25 is a cross-sectional view of neck portion 12 of the golf club as the comparative example.

For the golf club of comparative example, a bar-shaped carbon steel that originally has the diameter of about 27 mm is used, on which the drawing process of the method of manufacturing a golf club in accordance with the present embodiment is not performed.

The golf club as the comparative example is formed by performing area-reducing process on an end portion of carbon steel, three steps of coarse forging, and fine forging.

Here, as shown in FIG. 22, the face portion 11 of golf club in accordance with the present embodiment is almost free of any spots on its cross-section, and grain flows 13 are formed uniformly from the surface layer to the inside of face portion 11. Specifically, in the golf club in accordance with the present embodiment, not only in the face portion 11 of head 10 but also in neck portion 12, grain flows are formed uniformly in high density.

On the other hand, as shown in FIG. 24, spots are seen on the cross section of face portion 11 of the golf club as the comparative example. Grain flows 13 are formed concentrated on the surface layer side, rather than in the inside of face portion 11.

Thus, it can be understood that in the golf club in accordance with the present embodiment, grain flows 13 are distributed with higher uniformity than in the golf club as the comparative example. Further, in the golf club in accordance with the present embodiment, density of grain flows 13 inside the face portion 11 is higher than in the golf club as the comparative example.

As shown in FIG. 23, neck portion 12 of the golf club in accordance with the present embodiment is also free of any spots on its cross-section, and it can be seen that grain flows 13 are formed uniformly from the surface layer to the inside of neck portion 12.

On the other hand, as shown in FIG. 25, in the golf club in accordance with the comparative example, streaks are observed in the cross section of neck portion 12 where density of grain flows 13 is sparse along the direction of extension of neck portion 12. Thus, it can be understood that grain flows 13 are concentrated on the surface layer side than at the central portion of neck portion 12, in the comparative example.

As described above, in neck portion 12 of the golf club in accordance with the present embodiment, grain flows 13 are formed more uniformly from the surface layer side to the central portion, than in the neck portion 12 of comparative example.

Further, it can be seen that the density of grain flows 13 formed at the neck portion 12 of golf club in accordance with the present embodiment is higher than the density of grain flows 13 formed at the neck portion 12 of the golf club of comparative example.

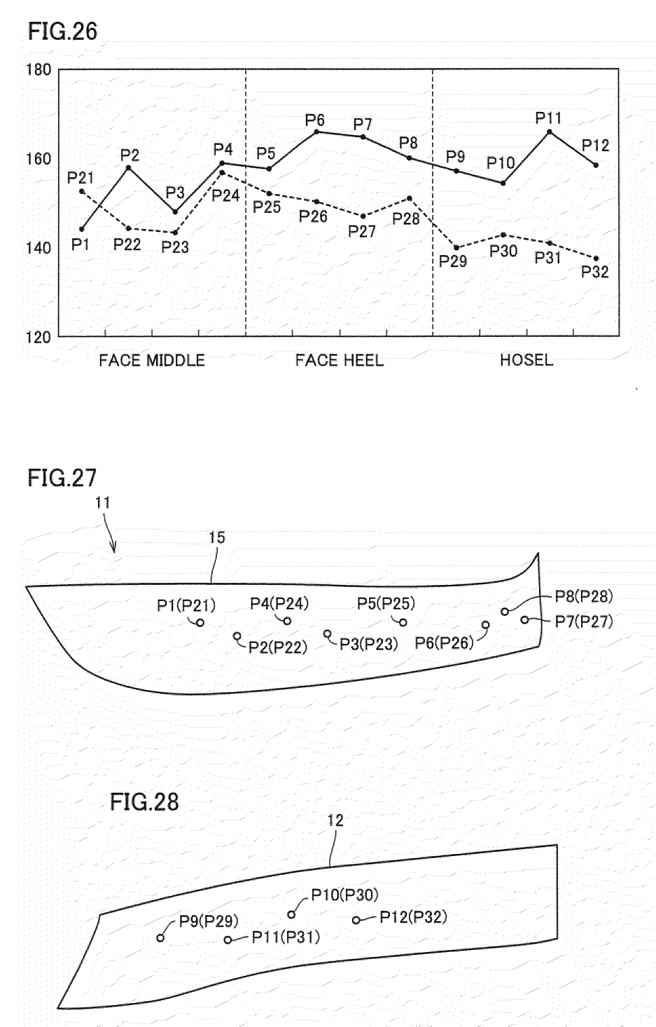

FIG. 26 is a graph showing the hardness of golf club in accordance with the present embodiment and the golf club as the comparative example.

In FIG. 26, the ordinate represents Vickers hardness (Hv). In the graph, the solid line represents Vickers hardness of various points (P1 to P12) of the golf club in accordance with the present embodiment, and the dotted line represents Vickers hardness of various points (P21 to P32) of the golf club in accordance with the comparative example.

Points of measurement are as shown in FIGS. 27 and 28. As can be seen from FIG. 26, at most points, the golf club in accordance with the present embodiment has higher hardness than the golf club in accordance with the comparative example.

Here, it can be seen that at points P2, P3, P6, P7, P11 and P12 positioned inside the golf club, the difference in hardness between the golf club of the present embodiment and that of comparative example is significantly large.

Particularly, at the hosel, the difference in hardness is as large as about 20 (Hv).

Possible reason why the hardness is improved in the golf club of the present embodiment than in the comparative example is that distribution density of grain flows is higher in the golf club of the present embodiment than in the golf club of comparative example, and that the distribution is more uniform.

As the hardness of golf club head 10 can be improved, strength can also be improved and, therefore, thickness of face portion 11 and head 10 can be reduced.

That the face portion 11 and head portion 10 can be made thinner enables more flexible weight design of head 10.

Specifically, it is possible to arrange the center of gravity of head 10 to a lower back side to enlarge a sweet area, or to design the weight balance of head 10 such that the sweet spot is positioned closer to the meet point. The sweet spot refers to an intersection of a face surface and a line extended vertically downward to the face surface from the center of gravity of an iron head.

Trial was performed by ten players using the golf club in accordance with the present embodiment and the golf club of the comparative example (Comparative Example), and eight of the players expressed “good hitting feeling.” Table 1 shows the result.

TABLE 1

| Player | Comments |
|---|---|
| Player 1: | The ball more firmly bites the face than Comparative Example. |
| professional | Easier to selectively hit a draw or fade, and easier to control. |
| golfer | |
| Player 2: HC: 5, | Softer hitting feeling than Comparative Example. The ball more |
| H/S: 46 m/s | firmly bites the face. |
| Player 3: HC: 3, | More stable hitting feeling than Comparative Example, with core. |
| H/S: 44 m/s | |
| Player 4: HC: 6, | Softer hitting feeling than Comparative Example, very stable. |
| H/S: 47 m/s | |
| Player 5: HC: 10, | The ball rides on the face better than Comparative Example. |
| H/S: 43 m/s | Very soft hitting feeling. |
| Player 6: HC: 11, | More stable and heavier hitting feeling than Comparative Example. |
| H/S: 40 m/s | Comfortable hitting feeling. |
| Player 7: HC: 9, | Softer hitting feeling than Comparative Example. The ball well |
| H/S: 42 m/s | rides on the face. |
| Player 8: HC: 3, | The ball rides on the face better than Comparative Example and it |
| H/S: 46 m/s | feels easier to control the ball. |
| Player 9: HC: 12, | More stable and softer hitting feeling than Comparative Example. |
| H/S: 46 m/s | |
| Player 10: HC: 14, | The ball rides on the face better than Comparative Example. |
| H/S: 44 m/s | Very soft hitting feeling. |

Here, HC represents handicap, and H/S represents head speed. “Fade” refers to a ball that once goes to the left side of ball flying line and then curves to the right, while “draw” refers to a ball that once goes to the right side of ball flying line and then curves to the left.

As described above, it can be understood that the golf club in accordance with the present embodiment attains good hitting feeling.

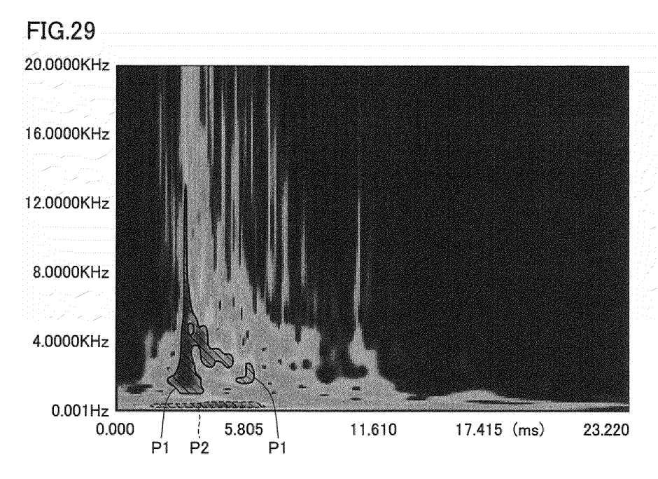

Through intensive study, the inventors found that, in short, the hitting feeling substantially depends on hitting sound. Specifically, while the players of trial shown in Table 1 express good hitting feeling in various phrases, the good feeling comes from good hitting sound. Particularly, the player feels good when the hitting sound has relatively low frequency and long reverberation, leaving comfortable echo. FIG. 29 is a graph showing a result of measurement of sound generated at the trial of golf club in accordance with the present embodiment. The ordinate represents frequency (KHz) of sound and the abscissa represents time (ms). Areas P1 and P2 surrounded by the solid line and dotted line represent areas in which sound volume (decibel (dB)) is large.

As shown in FIG. 29, when a ball is hit by the golf club in accordance with the present embodiment, large sound generates in area P1 surrounded by the solid line and area P2 surrounded by the dotted line.

The sound in area P2 surrounded by the dotted line derives from the sound of head swooshing through the air and the frictional sound of golf club head touching the ground, and it is not directly related to the ball hitting sound. On the other hand, the sound in area P1 surrounded by the solid line represents the hitting sound of golf club head hitting the ball.

The sound in area P1 surrounded by the solid line is distributed in a range of relatively low frequency, and it can be seen that the sound lingers for a while.

It can be understood from above that the hitting sound when a ball is hit by the golf club in accordance with the present embodiment has relatively low frequency and lingers long with echo, which leads to the result of Table 1 that good hitting feeling is attained by the golf club in accordance with the present embodiment.

Though the present invention has been applied to an iron club in the embodiment above, the idea of the present invention is also applicable to a wood club face.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A golf club, comprising a golf head including a face portion with a ball hitting surface and a neck portion connecting said face portion to a shaft; wherein
grain flows are formed in said golf head, and density of said grain flows inside said golf head is made comparable to density of said grain flows at a surface layer portion of said golf head.

2. The golf club according to claim 1, wherein
said grain flows extend along a surface parallel to said ball hitting surface in said face portion.

3. A method of manufacturing a golf club, comprising:
the drawing step of drawing a bar-shaped member to reduce diameter of said bar-shaped member;
the reducing step of reducing diameter of one end of said bar-shaped member that has been drawn at said drawing step, to be smaller than the diameter of the other end;
the bending step of bending said bar-shaped member; and
the forging step, following said bending step, of forging said bar-shaped member to integrally form the face portion and the neck portion.

4. The method of manufacturing a golf club according to claim 3, wherein
said drawing step includes the step of hardening at least a part of circumferential surface of said bar-shaped member, while retaining grain flows.

5. The method of manufacturing a golf club according to claim 3, wherein
said forging step includes a first forging step of performing a plurality of coarse forging steps on said bar-shaped member to bring said bar-shaped member closer to a final shape while retaining grain flows, and
a second forging step of performing fine forging process on a body resulting from the coarse forging steps, to attain the final shape.
